(19) United States
(12) Patent Application Publication
(10) Pub. No.: US 2024/0220886 A1
(43) Pub. Date: Jul. 4, 2024

(54) POWER USAGE AND RESOURCE OPTIMIZATION USING MACHINE LEARNING

(71) Applicant: PAYPAL, INC., San Jose, CA (US)

(72) Inventor: Adam Inzelberg, Tel Aviv (IL)

(21) Appl. No.: 18/090,284

(22) Filed: Dec. 28, 2022

(51) Int. Cl. G06Q 10/0631; F24F 11/47

(52) U.S. Cl. CPC G06Q 10/06312; F24F 11/47

(57) ABSTRACT

Various systems, computer-implemented methods, and computer program products are disclosed that use improved machine learning models and techniques for allocating physical resources such as electricity and HVAC systems. These techniques may use data, such as image data, text data, location data, or other similar types of data, indicative of a movement of objects associated with a time period. A machine learning model may extract a first set of features from the data and may determine a physical resource allocation based on the first set of features and a reference dataset. A machine learning model may determine a dynamic configuration of one or more physical resources associated with a physical building space based on the physical resource allocation. These techniques may dynamically configure usage of the one or more physical resources associated with the physical building space based on the physical resource allocation.

### FIELD

The present disclosure relates to the field of building management systems. More particularly, this disclosure relates to predicting and optimizing energy and resource usage based on machine learning analysis of real-time traffic data, according to various embodiments.

### BACKGROUND

Power consumption optimization is an area of priority with the emergence of environmentally conscientious initiatives. Shifts towards remote work being adopted by employers have led to fluctuating employee schedules where a portion of their time is spent working remotely. Thus, on any given day, it may be unclear how much electricity or other resources may be required by a building or section of a building (e.g., if 500 people work in an office building on one day, electricity requirements will be higher than if only 75 people are in the building that day). Buildings may thus end up using significantly more resources than are necessary, which causes unneeded power consumption, emission of greenhouse gases, wear and tear on mechanical systems, etc. Accordingly, applicant recognizes a need for better allocation of physical resources in order to avoid such wastage.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts an example, non-limiting system, according to some embodiments.

FIGS. 2 and 3 depict a method for determining a physical resource allocation, according to some embodiments.

FIGS. 4A and 4B depict a block diagram illustrating a network based system, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Various embodiments herein include systems, computer-implemented methods, apparatuses, and/or computer program products that can facilitate obtaining live data points and leveraging machine learning models to determine a physical resource allocation. Various embodiments herein may also train machine learning models to analyze data indicative of a movement of objects and evaluate whether the data matches a reference dataset to determine the physical resource allocation. Once the machine learning model is trained to evaluate various datasets and recognize a similarity between analysis results, the machine learning models may be applied to live data points. In some embodiments, the machine learning model and the computing device may dynamically configure one or more resources based on the physical resource allocation to optimize utilization of the one or more resources. Various embodiments herein may leverage the machine learning models to determine a dynamic configuration of the one or more resources based on the physical resource allocation, resulting in optimally efficient orchestration of the resources of the physical building space efficient asset allocation. In some embodiments, the computing device may include a scheduling module. In some embodiments, the scheduling module may dynamically allocate workstations to users based on the physical resource allocation and the dynamic configuration scheme determined by the machine learning model. As used herein, “workstations” may include an office, cubicle, meeting room, conference room, restroom, break rooms, recreation rooms, other areas associated with a physical building space, or the like. For example, in some embodiments, workstation allocations by the computing device responsive to a workstation request/reservation from a user may be limited to zones (e.g., floors or sections of floors) where HVAC is actively operational based on the physical resource allocation. Accordingly, various embodiments herein can improve the operation of a computing device and other systems associated with a physical building space as described herein by reducing cycles, reducing loads, decreasing time to determine the physical resource allocation based on live data, reducing time to dynamically configure usage of the physical resources, reducing wear on the systems, reducing the frequency of maintenance based on usage, and other characteristics. In various embodiments, the one or more resources may include, but is not limited to, electrical power, water, lighting, HVAC, workstations, consumables, other physical resources corresponding to the physical building space, or any combinations thereof. As used herein, “consumables,” can include office supplies, food, other products, and the like. Various embodiments herein can improve the efficiency of systems, improve conservation of the one or more physical resources, reduce demand and consumption based on the physical resource allocation.

Accordingly, techniques herein can improve computer performance by providing greater accuracy of data models, leading to more accurate classification by machine learning engines, saving processor cycles, memory usage, and power usage. Techniques herein can also improve computer performance by providing more efficient resource configuration models for operation and control of building management systems (e.g., electrical power distribution systems, lighting systems, water supply systems, HVAC systems, etc.) by the machine learning engines and by leading to more efficient physical resource allocation schemes that are implemented by computing devices and other system controllers, saving on processor cycles, memory usage, and power usage by those devices.

It should be appreciated that additional manifestations, configurations, implementations, protocols, etc. can be utilized in connection with the following components described herein or different/additional components as would be appreciated by one skilled in the art.

However, not all of these components may be required to practice one or more embodiments, and variations in the arrangement and type of the components may be made without departing from the spirit or scope of various embodiments of the present disclosure.

In some embodiments, a computer-implemented method includes obtaining, by a computer system from a first computing device, a first dataset indicative of a movement of objects associated with a first time period, extracting, by the computer system and via execution of a first machine learning model, a first set of feature values based on the first dataset, determining, by the computer system, a physical resource allocation based on the first set of feature values and a reference dataset; and dynamically configuring, by the computer system, usage of one or more physical associated with a physical building space based on the physical resource allocation.

In some embodiments, the computer-implemented method further includes determining, by the computer system and via execution of a second machine learning model, the dynamic configuration of the one or more physical resources based on the physical resource allocation.

In some embodiments, the dynamic configuration of the one or more physical resources further includes allocating a plurality of workstations associated with the physical building space based on a ranking of each workstation of the plurality of workstations.

In some embodiments, the computer-implemented method further includes obtaining, by the computer system from the first computing device, data indicative of the movement of objects associated with a second time period, extracting, by the computer system and via execution of the first machine learning model, a second set of feature values based on the data indicative of the movement of objects associated with the second time period, obtaining, by the computer system, data representative of the physical resource allocation based on the second time period, determining, by the computer system, a reference dataset based on the second set of feature values and the physical resource allocation data, and training, by the computer system, the first machine learning model based on the reference dataset.

In some embodiments, the first dataset includes one or more images captured by one or more recording devices.

In some embodiments, extracting the first set of feature values from the one or more images further includes applying, via the first machine learning model, one or more computer vision techniques to the one or more images, identifying, by the computer system, one or more pixel groups in the one or more images, determining, by the computer system, a first set of characteristics based on the one or more images and associating the first set of characteristics to the one or more pixel groups, and deriving, by the computer system, a traffic density based on the first set of characteristics and the first set of feature values.

In some embodiments, the one or more images include scenes of a vehicle pathway.

In some embodiments, the one or more images include scenes of one or more public transportation stations.

In some embodiments, the first dataset includes one or more images captured by one or more recording devices. In some embodiments, the computer-implemented method further includes obtaining, by the computer system from a second computing device, text data indicative of an increase or decrease to the physical resource allocation associated with the first time period, and extracting, by the computer system and via execution of the first machine learning model, a third set of feature values based on the text data. In some embodiments, determining the physical resource allocation is further based on the third set of feature values.

In some embodiments, extracting the third set of feature values from the text data includes identifying, by the computer system and the first machine learning model, one or more key terms in the text data, determining, by the computer system, a second set of characteristics based on the key terms and the text data, and deriving, by the computer system, an indication corresponding to the increase or decrease to the physical resource allocation based on the third set of feature values and the second set of characteristics.

In some embodiments, a system includes one or more processors, and a non-transitory computer readable medium having stored thereon instructions that are executable by the one or more processors to cause the system to perform operations including obtain a first dataset indicative of a movement of objects associated with a first time period from a first computing device, extract, via execution of a first machine learning model, a first set of feature values based on the first dataset, determine a physical resource allocation based on the first set of feature values and a reference dataset, determine, via execution of a second machine learning model, a dynamic configuration of one or more physical resources associated with a physical building space based on the physical resource allocation, and dynamically configure usage of the one or more physical resources associated with the physical building space based on the physical resource allocation.

In some embodiments, determining the dynamic configuration of the one or more physical resources associated with the physical building space further includes allocating a plurality of workstations associated with the physical building space based on a ranking of each workstation of the plurality of workstations.

In some embodiments, the system further includes obtain data indicative of the movement of objects associated with a second time period from the first computing device, extract a second set of feature values based on the data indicative of the movement of objects associated with the second time period, obtain data representative of the physical resource allocation based on the second time period, determine a reference dataset based on the second set of feature values and the physical resource allocation data, and train the first machine learning model based on the reference dataset.

In some embodiments, the system further includes obtain data representative of the configuration of the one or more physical resources associated with the physical building space based on the second period of time, extract a third set of feature values based on data representative of the configuration of the usage of the one or more physical resources, and training the second machine learning model based on the reference dataset. In some embodiments, the reference dataset further comprises the third set of feature values.

In some embodiments, the system further includes a building management system. In some embodiments, the building management system includes an electrical distribution system. In some embodiments, dynamically configuring usage of the one or more physical resources associated with the physical building space within the second time period causes the system to further perform operations including configure the electrical distribution system to reduce a power consumption based on the physical resource allocation.

In some embodiments, the system further includes a building management system. In some embodiments, the building management system further includes a HVAC system. In some embodiments, dynamically configuring usage of one or more physical resources associated with the physical building space within the second time period further causes the system to further perform operations including control the HVAC system to isolate unallocated zones based on the physical resource allocation.

In some embodiments, a computer program product embodied on one or more non-transitory computer readable media having stored thereon instructions that are executable by one or more processors to cause the computer program product to perform operations including obtain a first dataset indicative of a movement of objects associated with a first time period from a first computing device, extract, via execution of a first machine learning model, a first set of feature values based on the first dataset, determine a physical resource allocation based on the first set of feature values and a reference dataset, determine, via execution of a second machine learning model, a dynamic configuration of one or more physical resources associated with a physical building space based on the physical resource allocation, and dynamically configuring usage of the one or more physical resources associated with the physical building space within a second time period based on the physical resource allocation.

In some embodiments, the first dataset comprises one or more images captured by one or more recording devices. In some embodiments, extracting the first set of feature values from the one or more images causes the computer program product to further perform operations including apply one or more computer vision techniques to the one or more images, identify one or more pixel groups in the one or more images, determine a first set of characteristics from the one or more images and associating the first set of characteristics to the one or more pixel groups, and derive a traffic density based on the first set of characteristics and the first set of feature values.

In some embodiments, the computer program product further performs operations including obtain text data indicative of an increase or a decrease to the physical resource allocation within the first time period from a second computing device, identify, by the first machine learning model, one or more key terms in the text data, determine a second set of characteristics based on the one or more key terms, extract, via execution of the first machine learning model, a third set of feature values based on the text data and the second set of characteristics, and derive an indication of the increase of the decrease to the physical resource allocation based on the third set of feature values and the second set of characteristics. In some embodiments, the physical resource allocation is further based on the third set of feature values.

In some embodiments, dynamically configuring usage of the one or more physical resources associated with the physical building space based on the physical resource allocation causes the computer program product to further perform operations including control an electrical distribution in the physical building space to conserve a power usage based on the physical resource allocation, control a HVAC system to isolate unoccupied zones in the physical building space based on the physical resource allocation, and allocate a plurality of workstations associated with the physical building space based on a ranking of each workstation of the plurality of workstations.

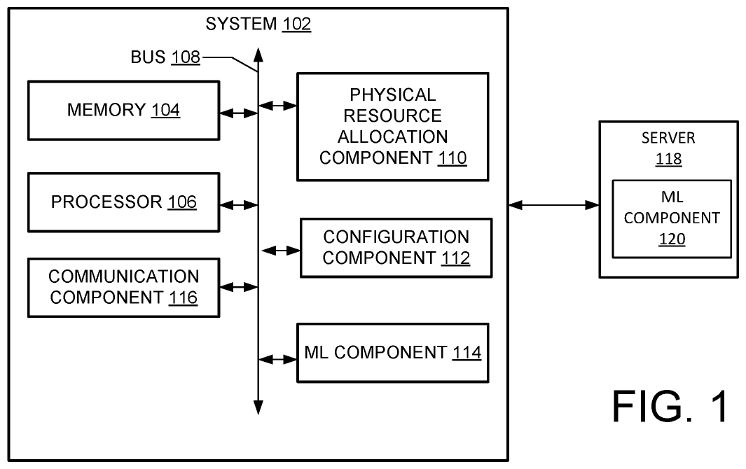

Turning to FIG. 1, there is depicted an example, non-limiting system 102, according to some embodiments. System 102 may be a computerized tool (e.g., any suitable combination of computer-executable hardware and/or computer-executable software) which can be configured to perform various operations relating to physical resource allocation and dynamic configuration of resources of the facility. The system 102 may include one or more of a variety of components, such as memory 104, processor 106, bus 108, physical resource allocation component 110, configuration component 112, machine learning (M.L.) component 114, and/or communication component 116. In various embodiments, the system 102 can be communicatively coupled to a server 118.

In various embodiments, one or more of the memory 104, processor 106, bus 108, physical resource allocation component 110, configuration component 112, M.L. component 114, and/or communication component 116, may be communicatively or operably coupled (e.g., over a bus or wireless network) to one another to perform one or more functions of the system 102. In some embodiments, the memory 104 may be a non-transitory computer readable media having stored thereon instructions executable by the system 102 to perform various operations as discussed herein.

In various embodiments, the system 102 may obtain data indicative of a movement of objects (e.g., volume flow density) from an external computing device (i.e., a first computing device). In some embodiments, the data may be obtained from a data store electronically communicable with the system 102. In other embodiments, the data may be obtained from a web browser application associated with the external computing device. The data indicative of movement of objects may form one or more datasets utilized by various embodiments herein to determine the physical resource allocation. In some embodiments, the data may be stored as one or more datasets in the memory 104. In some embodiments, the data indicative of the movement of objects may be associated with a first time period. In some embodiments, the first time period may occur during a given day. In some embodiments, the data indicative of the movement of objects may be associated with a second time period. In some embodiments, the first time period occurs subsequent to the second time period. In some embodiments, the second time period may include one or more time periods. In some embodiments, the second time period may include one or more time periods each time period occurring over a day of the one or more days. In some embodiments, the first time period is subsequent to the second time period. Accordingly, in some embodiments, the one or more days of the second time period occurred prior to the given day of the first time period. In various embodiments, the first time period and the second time period may be a specified time period. In some embodiments, the time periods may be determined by a user associated with the entity. Furthermore, in some embodiments, the first time period and the second time period may occur during a substantially similar time period during the day. For example, the first time period and the second time period may be between the times of 6 A.M. and 9 A.M.

In various embodiments, the physical resource allocation component 110 may include data representative of a physical resource allocation. In some embodiments, the data representative of the physical resource allocation may be based on data indicative of the movement of objection. In some embodiments, the data representative of the physical resource allocation may be representative of a number of users (e.g., office employees) predicted to arrive at a physical building space. In some embodiments, the physical resource allocation may be based on the first time period. In some embodiments, the physical resource allocation may be based on the second time period. In other embodiments, the physical resource allocation component 110 may include data based on the first time period, the second time period, and other time periods. In some embodiments, the data representative of the physical resource allocation may be based on data indicative of the movement of objection.

In various embodiments, the configuration component 112 may include data representative of a configuration of one or more physical resources corresponding to a physical building space. In some embodiments, the configuration may be based on the physical resource allocation. In some embodiments, the configuration component 112 may include data representative of an allocation of a plurality of workstations based on a ranking of each workstation associated with the physical building space. Accordingly, in some embodiments, the configuration component 112 may include data representative of the rankings of each of the workstations based on the configuration of the other physical resources of the physical building space. In some embodiments, the configuration component 112 may include data representative of configuration of a building management system, electrical distribution system, lighting systems, HVAC systems, workstations, other physical resources associated with the physical building space or the entity, or any combinations thereof.

In some embodiments, the physical resource allocation component 110 and the configuration component 112 may include data representative of a reference dataset. In some embodiments, the reference dataset may include data indicative of the movement of objects associated with the second time period. In some embodiments, the reference dataset may include data representative of a historical physical resource allocation. In some embodiments, the reference dataset may include data indicative of the historical configuration of the one or more physical resources corresponding to the physical building space based on the physical resource allocation.

In various embodiments, the M.L. component 114 may include data representative of a machine learning model. Furthermore, in various embodiments, the system 102 may apply the machine learning model to one or more datasets to determine a physical resource allocation and/or a dynamic configuration of one or more physical resources associated with a physical building space. To that end, the system 102 may obtain one or more datasets to determine the physical resource allocation and/or configuration of the one or more physical resources. In some embodiments, the machine learning model may be configured to extract a first set of feature values from the data indicative of the movement of objects associated with the first time period, determine a physical resource allocation based on the first set of feature values, and dynamically configure usage of one or more physical resources based on the physical resource allocation. In some embodiments, the machine learning model may determine the physical resource allocation based on the first set of feature values and a reference dataset. In various embodiments, the reference dataset may include data indicative of the movement of objects for the second time period. Thus, in some embodiment, the machine learning model may determine the physical resource allocation based on an evaluation of a comparison between the first set of feature values and the reference dataset.

The one or more datasets may include live data points corresponding to data including, but not limited to, image data, text data, location data, other data, or any combinations thereof as discussed herein. In some embodiments, the machine learning model may obtain the one or more datasets and apply one or more models and/or techniques to the one or more datasets to determine the physical resource allocation, the configuration of the one or more physical resources, or any combinations thereof. In a non-limiting example, the one or more datasets may include a first dataset and a second dataset, the first dataset corresponding to image data and the second dataset corresponding to text data. In another non-limiting example, the physical resource allocation may be based on image data of a highway leading to the physical building space, a train station in an area of the physical building space, and text data obtained from a web application providing information on weather and traffic in an area of the physical building space.

In some embodiments, the live data points may include data indicative of the movement of objects associated with the first time period. In some embodiments, the data may include one or more images captured by one or more recording devices associated with the first computing device. In some embodiments, the one or more images may include scenes of a vehicle pathway (e.g., highway, interstate, bridge, street, boulevard, avenue, road, etc.). In some embodiments, the one or more images comprise scenes of one or more public transportation stations (e.g., rail stations, train stations, bus stations, etc.). In some embodiments, the one or more images may be from a recording device associated with an aerial vehicle. In some embodiments, the aerial vehicle may be a drone. In some embodiments, the aerial vehicle may be an autonomously piloted drone. In some embodiments, the aerial vehicle may be in electrically communicable connection with the system 102. In some embodiments, the system 102 may control an operation of the aerial vehicle.

In some embodiments, the machine learning model may include one or more computer vision techniques. In some embodiments, the machine learning model may apply one or more computer vision techniques to the one or more images. The computer vision techniques may be configured to identify one or more pixel groups in the one or more images. In some embodiments, the one or more pixel groups may include one or more pixels representative of any of a plurality of objects observed by the machine learning model and identified as an object moving through the one or more images. In some embodiments, the objects may include vehicles, persons, animals, or other objects moving across a scene of one or more images. In various embodiments, vehicles may include, but is not limited to, cars, SUVs, motorcycles, bicycles, trucks, tractor trailers, airplanes, trains, buses, other vehicles, or combinations thereof. In some embodiments, the machine learning model may determine a first set of characteristics based on the one or more images and the one or more pixel groups. In some embodiments, the machine learning model may associate the first set of characteristics to the one or more pixel groups and the one or more images. Moreover, in some embodiments, the machine learning model may determine a traffic density based on the one or more images, the first set of characteristics, the first set of feature values, or combinations thereof. In some embodiments, the machine learning model may include a vision machine learning model. In some embodiments, the machine learning model may include a vision density model. In some embodiments, the machine learning model may apply the vision machine learning model to identify the one or more pixel groups in the one or more images.

In some embodiments, the machine learning model may receive data representative of results based on applying the one or more computer vision techniques to the one or more images. In some embodiments, the machine learning model may generate a results data based on applying the one or more computer vision techniques to the one or more images and may form a results dataset. In some embodiments, the results dataset may include data pairs corresponding to the one or more pixel groups such as the first set of feature values, the first set of characteristics, object classification, other data, or combinations thereof. In some embodiments, the feature pair may include qualitative and quantitative data corresponding to the one or more pixel groups. For example, in some embodiments, the results dataset may include a classification of the one or more pixel groups, an identification of the object or objects in the pixel group, a speed of the object or objects, a traffic density associated with the object or objects, a confidence score, other data, or combinations thereof.

In some embodiments, the live data points may include text data. Accordingly, in various embodiments, the machine learning model may apply one or more techniques to extract feature values from the text data. In some embodiments, the machine learning model may apply natural language processing techniques to the text data to extract the feature values. In some embodiments, the feature values correspond to key terms or phrases from the text data corresponding to an increase or decrease in the physical resource allocation. In some embodiments, the feature values extracted from the text data correspond to an increase or a decrease in the physical resource allocation indicative of the number of employees that physically come to the entity physical building space for the given day. In various embodiments, extracting the first set of feature values includes determining a first set of characteristics based on the key terms or phrases from the text data. For example, in some embodiments, the characteristics can correspond to any of a plurality of characteristics including, but not limited to, type, confidence score, reliability score, accuracy score, hierarchical rankings, other characteristics, or any combinations thereof.

In some embodiments, the system 102 may obtain image data from a first computing device to determine an initial physical resource allocation and the system 102 may obtain text data from a second computing device indicative of an increase or a decrease to the physical resource allocation associated with the first time period. To that end, the machine learning model may extract a third set of feature values based on the text data.

In some embodiments, the machine learning model may include a natural language processing (“NLP”) model. In some embodiments, the machine learning model may apply the NLP model to the text data to extract the third set of feature values based on the text data. In some embodiments, the machine learning model may extract the third set of feature values from the text data by identifying one or more key terms in the text data. The machine learning model may then determine a second set of characteristics based on the key terms and the text data corresponding to the increase or decrease to the physical resource allocation based on the text data and derive an indication corresponding to the increase or the decrease to the physical resource allocation based on the text data, the third set of feature values, and the second set of characteristics. In some embodiments, the physical resource allocation may be further based on the indication corresponding to the increase or the decrease. In some embodiments, the machine learning model may apply supervised or unsupervised machine learning models to the text data to identify the key terms and to determine the second set of characteristics indicative of the increase or the decrease to the physical resource allocation.

In some embodiments, the live data points may include sensor data corresponding to GPS location data. The sensor data may be associated with a plurality of computing devices. Each computing device of the plurality of computing devices may be associated with a user. In some embodiments, the sensor data may correspond to cell tower location data in communicable connection with the plurality of computing devices. In various embodiments, the plurality of computing devices may be a plurality of cellular telephones or other mobile devices. In some embodiments, plurality of computing devices may be associated with each worker in a workforce.

In some embodiments, the live data points may include one or more images captured by one or more recording devices attached to one or more aerial vehicles (e.g., drones). In some embodiments, the unmanned aerial vehicles may be remotely piloted aerial vehicles. In other embodiments, the unmanned aerial vehicles may be autonomously piloted drones. Each aerial vehicle may survey various different pathways to determine a volume flow density in one or more scenes in an area associated with the entity.

In various embodiments, the live data points may include sensor data corresponding to GPS location data associated with one or more users and computing devices associated with each of the one or more users. In various embodiments, the machine learning model may apply one or more techniques to extract feature values from the GPS location data. In some embodiments, the feature values extracted from the GPS location data may correspond to a volume flow projection for the one or more users. In some embodiments, the machine learning model may extrapolate the volume flow projection for an area based on the sensor data and the feature values extracted from the sensor data. In various embodiments, the machine learning model may determine characteristics corresponding to the feature values and the sensor data. For example, in some embodiments, the characteristics can correspond to any of a plurality of characteristics including, but not limited to, type, confidence score, reliability score, accuracy score, hierarchical rankings, other characteristics, or any combinations thereof. Accordingly, in some embodiments, the physical resource allocation for a given day may be further based on the sensor data, the feature values, the characteristics based on the feature values and sensor data, or combinations thereof.

In various embodiments, the reference dataset may include live data points obtained from one or more external computing devices corresponding to historical data including, but not limited to, image data, text data, location data, other data, or any combinations thereof as discussed herein. In some embodiments, the reference dataset may be based on historical data associated with the second time period. In some embodiments, the machine learning model may be trained based on the reference dataset as will be further discussed herein. In some embodiments, the reference dataset may be used by the system 102 or the machine learning model to determine the physical resource allocation, the configuration of the one or more physical resources, or combinations thereof. In some embodiments, the reference dataset may include live data points associated with a second time period that were obtained on one or more days. For example, the reference dataset may include image data obtained during the morning rush hour for each working day over a period of 180 days. In some embodiments, the historical data may include resource allocation data and configuration data for the one or more physical resources associated with the second time period. In some embodiments, the second time period may be substantially similar to the first time period. In some embodiments, the second time period may include a time period on a plurality of days.

It is noted that the foregoing can include model training which can be utilized in order to improve accuracy of models described herein. In various embodiments, model training can be performed using the system 102 or another system herein (e.g., server 118). In various embodiments, the system 102 and the M.L. component 114 (or M.L. component 120) may train the machine learning model based on a reference dataset. In some embodiments, training the machine learning model may include obtaining data indicative of the movement of objects associated with the second time period, extracting a second set of feature values based on the data indicative of the movement of objects associated with the second time period, obtaining data representative of the physical resource allocation based on the second time period, and determining a reference dataset based on the second set of feature values and the physical resource allocation data.

In some embodiments, the machine learning model may include a first machine learning model and a second machine learning model. In some embodiments, the first machine learning model may be configured to determine the physical resource allocation based on the first dataset. In some embodiments, the second machine learning model may be configured to determine the configuration of the one or more physical resources corresponding to the physical building space. In some embodiments, the second machine learning model may be further configured to dynamically configure usage of the one or more physical resources based on the physical resource allocation.

In various embodiments, the system 102 and the M.L. component 114 (or M.L. component 120) may train the second machine learning model based on the reference dataset. In some embodiments, training the second machine learning model may include obtaining data representative of the configuration of the one or more resources in the physical building space based on the second period of time, extracting a third set of feature values based on the data corresponding to the usage of the one or more physical resources, and training the second machine learning model based on the reference dataset. In some embodiments, the reference dataset further includes the third set of feature values.

According to various embodiments, the communication component 116 can transmit and receive data. In some embodiments, the communication component 116 can transmit the updated machine learning models and/or reference dataset to a server (e.g., server 118). In some embodiments, the communication component 116 can receive from the server (e.g., server 118), an updated machine learning model. In this regard, the updated machine learning models can be generated using M.L. component 120 of the server 118 applied to the datasets within the time period and/or the reference datasets (e.g., from the system 102) and other machine learning models associated with the system 102. In various embodiments, the reference datasets and the updated machine learning models can be stored in a local data cache associated with the memory 104.

According to an embodiment, the communication component 116 can access, via a server (e.g., server 118), reference datasets including historical data corresponding to the movement of objects, volume flow projections (e.g., traffic density), physical resource allocation, configuration of one or more physical resources corresponding to the physical building space, or combinations thereof. In this regard, the physical resource allocation and dynamic configuration can be further generated (e.g., by the physical resource allocation component 110 and the configuration component 112 respectively) based on the datasets obtained within the time period for the given day representative of live data points.

It can be appreciated that the communication component 116 can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.) The system 102 and/or various respective components can additionally comprise various graphical user interfaces (GUIs), input devices, or other suitable components.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or M.L. components (e.g., M.L. component 114 and/or M.L. component 120) herein can comprise artificial intelligence component(s) which can employ an artificial intelligence (AI) model and/or an M.L. model capable of learning to perform the above or below described functions (e.g., via training using historical training data and/or feedback data).

In some embodiments, M.L. component 114 and/or M.L. component 120 can comprise an A.I. and/or M.L. model that can be trained (e.g., via supervised and/or unsupervised techniques) to perform the above or below-described functions using historical training data comprising various context conditions that correspond to various management operations. In this example, such an A.I. and/or M.L. model can further learn (e.g., via supervised and/or unsupervised techniques) to perform the above or below-described functions using training data comprising feedback data, where such feedback data can be collected and/or stored (e.g., in memory) by an M.L. component 114 and/or M.L. component 120. In this example, such feedback data can comprise the various instructions described above/below that can be input, for instance, to a system herein, over time in response to observed/stored context-based information.

A.I./M.L. components herein can initiate an operation(s) associated with a based on a defined level of confidence determined using information (e.g., feedback data). For example, based on learning to perform such functions described above using feedback data, performance information, and/or past performance information herein, an M.L. component 114 and/or M.L. component 120 herein can initiate an operation associated with physical resource allocation and/or dynamic configuration of resources. In another example, based on learning to perform such functions described above using feedback data, an M.L. component 114 and/or M.L. component 120 herein can initiate an operation associated with updating a model (e.g., a tuning model herein).

In some embodiments, the M.L. component 114 and/or M.L. component 120 can perform a utility-based analysis that factors cost of initiating the above-described operations versus benefit. In this embodiment, an artificial intelligence component can use one or more additional context conditions to determine an appropriate distance threshold or context information, or to determine an update for a tuning model.

To facilitate the above-described functions, an M.L. component herein can perform classifications, correlations, inferences, and/or expressions associated with principles of artificial intelligence. For instance, an M.L. component 114 and/or M.L. component 120 can employ an automatic classification system and/or an automatic classification. In one example, the M.L. component 114 and/or M.L. component 120 can employ a probabilistic and/or statistical-based analysis (e.g., factoring into the analysis utilities and costs) to learn and/or generate inferences. The M.L. component 114 and/or M.L. component 120 can employ any suitable machine-learning based techniques, statistical-based techniques and/or probabilistic-based techniques. For example, the M.L. component 114 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In other embodiments, the M.L. component 114 and/or M.L. component 120 can perform a set of machine-learning computations. For example, the M.L. component 114 and/or M.L. component 120 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, a set of different machine learning computations, or any combinations thereof.

In various embodiments, the M.L. component 114 and/or M.L. component 120 can employ any suitable computer vision based machine learning techniques, natural language processing (“NLP”) techniques, and/or vision density techniques. For example, the M.L. component 114 can employ computer vision techniques to extract one or more feature values and one or more characteristics corresponding to objects (e.g., persons or vehicles) obtained from one or more images from a recording device (e.g., camera) from a scene of a pathway (e.g., highway, road, street, boulevard, corridor, sidewalk, public transportation station, etc.). In another example, the M.L. component 114 can employ NLP techniques to extract one or more feature values and one or more characteristics corresponding to key terms or phrases obtained from text data from a website or external computing device (e.g., web browser application).

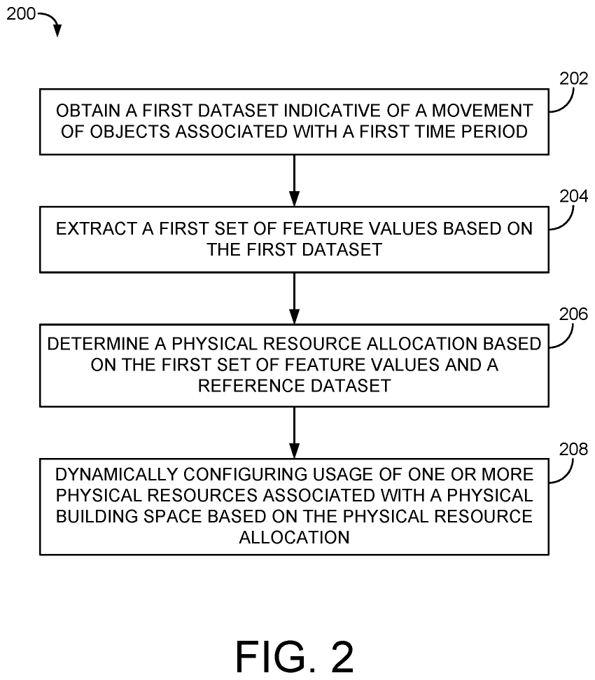

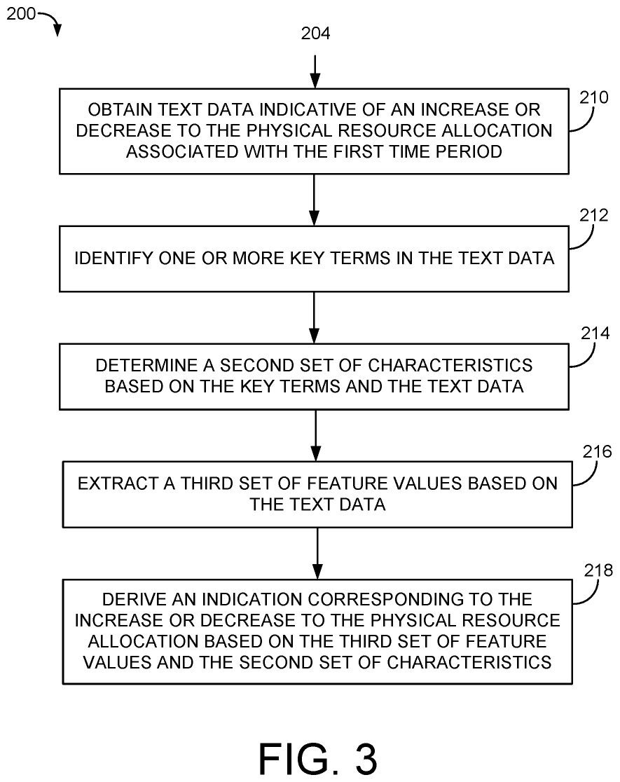

FIGS. 2 and 3 depict a method 200 for determining a physical resource allocation, according to some embodiments. Referring to FIG. 2, at 202, the method 200 includes obtaining a first dataset indicative of a movement of objects associated with a first time period. In some embodiments, the first dataset includes live data. In some embodiments, the first dataset may include one or more live data points corresponding to a volume flow density (e.g., traffic flow density) based on the movement of objects. In some embodiments, the first dataset may be obtained from one or more external computing devices or servers as will be further described herein.

In some embodiments, the first dataset may be associated with the first time period. In some embodiments, the first time period may precede a time threshold where usage of one or more physical resources corresponding to a physical building space may be predicted to be utilized. In some embodiments, the first time period may include a time period for a given day. In some embodiments, the first time period may be for a specific time period for a given day. For example, the first time period may be during a morning rush hour period before employees are expected to arrive at the physical building space. In another example, the first time period may be when volume flow density captured by the recording devices is typically at higher concentrations. It is to be understood that the first time period can include any of a plurality of time periods for a given day and is not limited to a specific time period.

In various embodiments, the first dataset may include one or more images. In some embodiments, the one or more images may be of a scene. In some embodiments, the one or more images may be of one or more scenes. The one or more images may be captured by a recording device. In some embodiments, the recording device may be in electrically communicable connection with an external computing device or server. In some embodiments, the first dataset includes one or more images captured by one or more recording devices. In some embodiments, the first dataset may include one or more images may be of a scene of a pathway. Accordingly, in some embodiments, the first dataset may include one or more images indicative of a movement of objects and corresponding to a volume flow density of objects (e.g., persons or vehicles) for a scene of a pathway.

In various embodiments, the first dataset may be associated with a first time period. In some embodiments, the first time period may be determined by a user associated with the system 102. In some embodiments, the machine learning model may determine the first time period. Accordingly, the machine learning model may determine the first time period based on historical data corresponding to volume flow density as will be further discussed herein. In some embodiments, the first time period may include one or more time intervals. The one or more time intervals occurring over the first time period. For example, the first dataset includes one or more images captured during a 30 minute time period and including images captured over 1 minute intervals every 5 minutes.

At 204, the method 200 includes extracting a first set of feature values based on the first dataset. In some embodiments, the machine learning model may extract the first set of features based on the first dataset. In some embodiments, the one or more images may include data corresponding to the first set of feature values. In some embodiments, the first set of feature values correspond to a traffic flow density.

In some embodiments, extracting the first set of feature values includes applying one or more computer vision models (or techniques) to the one or more images. In some embodiments, the machine learning model may apply one or more computer vision models (or techniques) to the one or more images. In some embodiments, the computer vision model (or technique) includes a computer vision machine learning technique. In some embodiments, the computer vision model (or technique) includes a vison density technique.

In some embodiments, extracting the first set of feature values includes identifying one or more pixel groups in the one or more images. In some embodiments, the machine learning model may apply the computer vision techniques to the one or more images to identify one or more pixel groups in the one or more images. The one or more pixel groups may correspond to objects. The objects may include vehicles, persons, and other objects.

In some embodiments, extracting the first set of feature values includes associating the first set of characteristics to the one or more pixel groups. In some embodiments, the machine learning model may associate the first set of characteristics to the one or more pixel groups. In some embodiments, each pixel group of the one or more pixel groups may include one or more characteristics. Accordingly, the one or more characteristics of each of the one or more pixel groups may form the first set of characteristics.

In some embodiments, extracting the first set of feature values includes determining a first set of characteristics based on the one or more images. In some embodiments, the machine learning model may determine the first set of characteristics based on the one or more images. In some embodiments, the first set of characteristics may correspond to the first set of feature values. In some embodiments, the first set of characteristics may correspond to the one or more pixel groups. In some embodiments, the first set of characteristics may correspond to any of a plurality of characteristics including, but not limited to, classification of the one or more pixel groups, an identification of the object or objects in the pixel group, a speed of the object or objects, a traffic density associated with the object or objects, a confidence score, other data, or combinations thereof. For example, in some embodiments, the characteristics can correspond to any of a plurality of characteristics including, but not limited to, object type, speed, confidence score, reliability score, accuracy score, hierarchical rankings, other characteristics, or any combinations thereof.

In some embodiments, extracting the first set of feature values includes determining a volume flow density (e.g., traffic density) based on the first set of characteristics and the first set of feature values. In some embodiments, the machine learning model may determine a volume flow density based on the first set of characteristics and the first set of feature values. In some embodiments, the machine learning model may apply one or more models or techniques to analyze the first set of feature values and the first set of characteristics to determine a volume flow density (e.g., traffic density). The term “traffic density” as used herein may thus refer in various embodiments to a quantity of vehicles (e.g., cars, buses, bicycles, scooters, etc.) in a particular area over a particular time period or may refer in various embodiments to a quantity of human persons in a particular area over a particular time period.

At 206, the method 200 includes determining a physical resource allocation based on the first set of feature values and a reference dataset. In various embodiments, the machine learning model may determine the physical resource allocation based on the first set of feature values and the reference dataset. In some embodiments, determining the physical resource allocation may be based on analysis of the first set of feature values and a reference dataset. In some embodiments, the physical resource allocation may be based on an evaluation by the machine learning model of a similarity between the first dataset and the reference dataset. In some embodiments, the physical resource allocation may be based on the similarity between the first set of feature values and the reference dataset. In some embodiments, the physical resource allocation may be based on the similarity between the first set of feature values and a reference set of feature values.

In various embodiments, the method 200 includes determining a dynamic configuration of one or more physical resources corresponding to a physical building space based on the physical resource allocation. In some embodiments, the machine learning model may determine the dynamic configuration of the one or more resources based on the physical resource allocation. In some embodiments, the dynamic configuration of the one or more resources may be based on historical data. In some embodiments, the dynamic configuration of the one or more resources may be based, in part, on historical data representative of the physical resource allocation based on a second time period.

In various embodiments, the system 102 may include historical data corresponding to one or more configuration models. The one or more configuration models corresponding to frameworks (e.g., schemes) for orchestrating the physical resources of the physical building space including, but not limited to, the building management system, electrical distribution system, lighting system, HVAC system, workstation allocation system, other physical resources, or combinations thereof. In some embodiments, the one or more configuration models may be configured to optimize utilization of usage of one or more physical resources corresponding to the physical building space based on the physical resource allocation for the given day. In some embodiments, the machine learning engine may include a first machine learning model and a second machine learning model. In some embodiments, the first machine learning model may determine the physical resource allocation. In some embodiments, the second machine learning model may determine the dynamic configuration of the one or more physical resources corresponding to the physical building space based on the physical resource allocation.

At 208, the method 200 includes dynamically configuring usage of the one or more physical resources corresponding to the physical building space based on the physical resource allocation. In some embodiments, the system 102 may be configured to control an HVAC system associated with the physical building space of the entity to isolate unoccupied zones in the physical building space based on the physical resource allocation. In some embodiments, the system 102 may be configured to control the electrical distribution associated with the physical building space of the entity to reduce an electrical power consumption in the physical building space based on the resource prediction. In some embodiments, the system 102 may be configured to control the lighting system associated with the physical building space of the entity to reduce an electrical power consumption in the physical building space based on the resource prediction. In other embodiments, the system 102 may be configured to control any of the other resources associated with the physical building space of the entity to optimize utilization of the resources. In some embodiments, the system 102 may be electrically communicable with one or more computing devices configured to control the one or more physical resources corresponding to the physical building space. For example, the system 102 may control an external computing device associated with the HVAC system associated with the physical building space. In some embodiments, the system 102 may transmit a dataset including data corresponding to controlling the one or more physical resources corresponding to the physical building space.

In some embodiments, the dynamic configuration of the one or more physical resources of the building may occur during a time period subsequent to the first time period on the given day. For example, the first time period is during a morning rush hour period for a given day and the dynamic configuration of the one or more physical resources is during the typical working hours on the given day when employees are utilizing the one or more physical resources of the physical building space.

In some embodiments, dynamic configuration of the usage of one or more physical resources corresponding to a physical building space further includes allocating a plurality of workstations based on a ranking of each workstation of the plurality of workstations associated with the physical building space. In some embodiments, the ranking of each workstation of the plurality of workstations may be based on a configuration of the other physical resources of the physical building space. To that end, in some embodiments, the ranking of each workstation of the plurality of workstations may be based on configuration of the HVAC system, electrical system, lighting system, portions thereof, or other physical resources. In some embodiments, the system 102 may control the allocation of the plurality of workstations. In some embodiments, the system 102 may be electrically communicable with an external computing device configured to control the allocation of the plurality of workstations. In some embodiments, the system 102 may transmit a dataset to the external computing device including data corresponding to the allocation of the plurality of workstations. For example, a computing device including a workstation scheduling application limits allocation of workstations responsive to requests from users to two floors of five available floors in an office space based on a prediction that 75 employees of the total 250 employees will arrive to work on the given day, and where electricity and HVAC resources were configured for the two floors. In another example, the system 102 configures the one or more physical resources (e.g., HVAC, power, lighting) for three zones associated with the physical building space and the system 102 sequentially allocates workstations in each the three zones before permitting allocation in other zones outside of the three zones, each subsequent zone being allocated based on a ranking of each zone as determined by the system 102 based on an optimized configuration of the one or more physical resources based on utilization and efficiency. Note that as used herein, the term “workstation” may refer to a particular physical space (e.g., cubicle, office, desk and chair location, conference room, other room, etc.) that is utilized by the user (e.g., employee) during their working day.

In various embodiments, the method 200 further includes training the machine learning model based on the reference dataset. In some embodiments, the method 200 further includes obtaining data indicative of the movement of objects associated with a second time period. In some embodiments, the data indicative of the movement of objects associated with the second time period may be a second dataset.

In some embodiments, the method 200 further includes extracting a second set of feature values based on the data indicative of the movement of objects associated with the second time period from the first computing device. In some embodiments, extracting the second set of feature values may include applying the one or more computer vision techniques to the one or more images, identifying one or more pixel groups in the one or more images, determining a set of characteristics based on the one or more images, associating the set of characteristics to the one or more pixel groups, and determining a traffic density based on the set of characteristics and the set of feature values as previously described herein. In some embodiments, the set of characteristics may be based on the one or more pixel groups. In some embodiments, the traffic density may be based on the set of characteristics and the second set of feature values. In some embodiments, the second set of feature values may be based on the physical resource allocation for the second time period and for the one or more days.

In some embodiments, the method 200 further includes obtaining data representative of the physical resource allocation based on the second time period. In some embodiments, the data representative of the physical resource allocation is based on historical data of the number of employees that arrived at the physical building space for the one or more days associated with the second time period.

In some embodiments, the method 200 further includes determining a reference dataset based on the second set of feature values and the physical resource allocation data. In some embodiments, the method 200 further includes training the machine learning model based on the reference dataset. In some embodiments, the machine learning model may include a first machine learning model trained on the second set of feature values and the physical resource allocation data.

In some embodiments, the method 200 includes determining the dynamic configuration of one or more physical resources based on the physical resource allocation. In some embodiments, the machine learning model may include a second machine learning model. Accordingly, in some embodiments, the second machine learning model may determine the dynamic configuration of the one or more physical resources based on the physical resource allocation. In some embodiments, the method 200 further includes obtaining data representative of the configuration of the one or more resources in the physical building space based on the second period of time. The configuration data based on the second period of time corresponds to configuration of the one or more physical resources associated with the physical building space for the second time period and the one or more days.

In some embodiments, the method 200 includes extracting a third set of feature values based on data representative of the configuration of the usage of the one or more physical resources. In some embodiments, the data representative of the configuration of the usage of the one or more physical resources may be for the one or more days associated with the second time period. In some embodiments, the method 200 further includes training the second machine learning model based on the reference dataset. In some embodiments, the reference dataset further includes the third set of feature values.

In some embodiments, the method 200 further includes configuring the electrical distribution system to reduce a power consumption based on the physical resource allocation. In some embodiments, the system 102 may be electrically communicable with a building management system. In some embodiments, the system 102 may include the building management system. In some embodiments, the building management system may include an electrical distribution system. In some embodiments, the building management system may include other physical resources in accordance with this disclosure. In some embodiments, dynamically configuring usage of the one or more physical resources includes configuring the electrical distribution system to reduce a power consumption at unallocated areas of the physical building space based on the physical resource allocation.

In some embodiments, the building management system includes the HVAC system. In some embodiments, dynamically configuring usage of the one or more physical resources includes configuring the HVAC system to isolate unallocated zones based on the physical resource allocation.

Referring to FIG. 3, in some embodiments, at 210, the method 200 includes obtaining text data indicative of an increase or a decrease to the physical resource allocation associated with the first time period from a second computing device. In some embodiments, the text data may be obtained via a web browser application from the second computing device. In some embodiments, at 212, the method 200 further includes identifying one or more key terms in the text data. In some embodiments, at 214, the method 200 further includes determining a second set of characteristics based on the key terms and the text data. The second set of characteristics may correspond to an increase or decrease in the physical resource allocation. The increase or decrease in the physical resource allocation may be based on any of a plurality of conditions that measurably affect the physical resource allocation associated with the entity including, but not limited to, weather, traffic impediments, holidays, school closures, other like conditions that may affect physical resource allocation, or any combinations thereof. For example, a weather report for the given day indicates a snowstorm is expected and the second set of characteristics may include data corresponding to a likelihood that the number of employees expected to arrive at the physical building space on the given day will be lower than an average expected value for the given day compared to historical data due to weather report.

In some embodiments, at 216, the method 200 includes extracting a third set of feature values based on the text data. The third set of feature values may correspond to key terms identified in the text data based on application of an NLP techniques to the text data by the machine learning model. In some embodiments, at 218, the method 200 may include deriving an indication corresponding to the increase or decrease to the physical resource allocation. In some embodiments, the indication may be based on the third set of feature values and the second set of characteristics.

In some embodiments, the method 200 further includes modifying the physical resource allocation based on the indication. In some embodiments, the physical resource allocation may be further based on the text data, the third set of feature values, the second set of characteristics, or combinations thereof. In some embodiments, extracting the third set of feature values based on the text data may further includes identifying one or more key terms in the text data, determining a second set of characteristics based on the key terms and the text data, and deriving an indication of the increase of the decrease to the physical resource allocation based on the third set of feature values and the second set of characteristics.

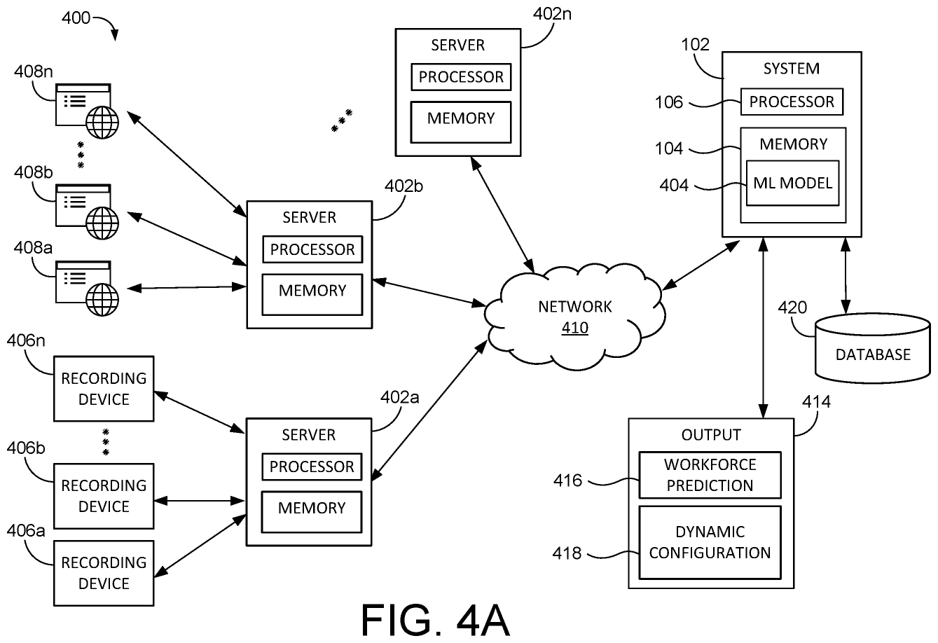

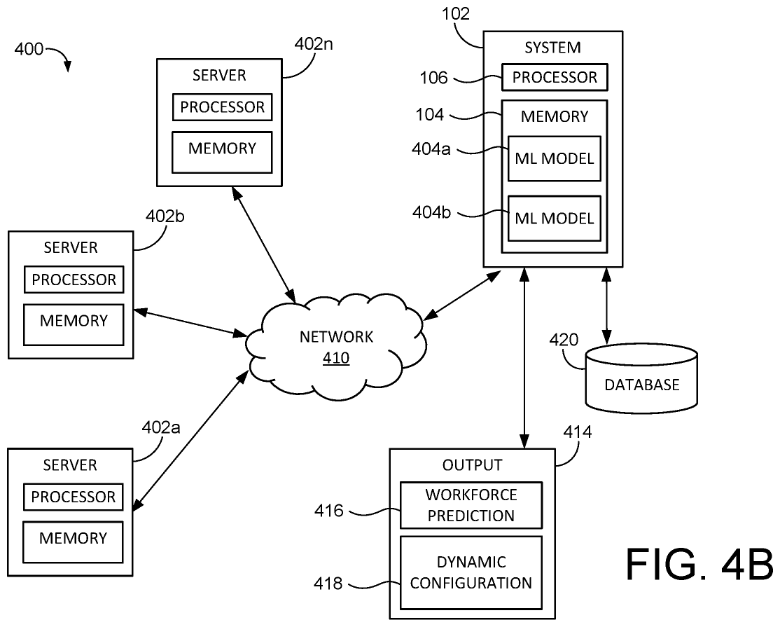

FIGS. 4A and 4B depict a block diagram illustrating a network based system 400, according to some embodiments. Unless stated otherwise, FIGS. 4A and 4B will be described collectively.

Not all of these components may be required to practice one or more embodiments, and variations in the arrangement and type of the components may be made without departing from the spirit or scope of various embodiments of the present disclosure. In various embodiments, the network based system 400 may include the system 102. The system 102 may be in communicable connection with a network 410 to receive and transmit information corresponding to dataset with other computing devices in communicable connection with the network 410. In some embodiments, the system 102 may be in communicable connection with external computing devices 402a, 402b through 402n to receive one or more datasets from external computing devices 402a, 402b through 402n corresponding to any of a plurality of data types including, but not limited to, image data, text data, location data, other data, or any combinations thereof.

In various embodiments, the system 102 may be electrically communicable with at least one external computing device of the external computing devices 402a, 402b through 402n to obtain a dataset from the at least one external computing device. In various embodiments, the at least one computing device may comprise external computing device 402a. In one example, the external computing device 402a may be in communicable connection with recording devices 406a, 406b through 406n configured to capture one or more images of scenes of pathways. In another example, the at least one computing device may comprise external computing device 402b and may include websites 408a, 408b through 408n displaying text data indicative of an increase or decrease in physical resource allocation based upon any of a plurality of factors that may affect employees associated with the entity to not physically come into work for the given day.

In various embodiments, the system 102 may receive the first dataset from at least one of the external computing devices 402a, 402b through 402n. In some embodiments, the system 102 may receive a first dataset from one of the external computing devices 402a, 402b through 402n and a second dataset from an other of the external computing devices 402a, 402b through 402n. In some embodiments, the system 102 may execute the machine learning model 404 to analyze the datasets obtained from the external computing devices 402a, 402b through 402n and generate an output 414. In some embodiments, the output 414 may include the physical resource allocation 416 indicative of the number of employees predicted to physically come into the physical building space of the entity on the given day. In some embodiments, the output 414 may include the dynamic configuration 418 indicative of configuration of the usage of one or more physical resources corresponding to a physical building space based on the physical resource allocation to optimize utilization of resources.

Referring to FIG. 4B, in various embodiments, the system 102 may include machine learning model 404a and machine learning model 404b. In some embodiments, machine learning model 404a may be configured to determine the physical resource allocation as discussed herein. In some embodiments, the machine learning model 404b may be configured to determine the dynamic configuration of the usage of one or more physical resources corresponding to a physical building space as discussed herein.

In some embodiments, the system 102 may be any type of processor-based platforms that are connected to a network 410 such as, without limitation, servers, personal computers, digital assistants, personal digital assistants, smart phones, pagers, digital tablets, laptop computers, Internet appliances, cloud-based processing platforms, and other processor-based devices. In some embodiments, the system 102 may be specifically programmed with one or more application programs in accordance with one or more principles/methodologies detailed herein. In some embodiments, the system 102 may be specifically programmed with one or more machine learning models 404 in accordance with one or more principles/methodologies detailed herein. In some embodiments, the system 102 may operate on any of a plurality of operating systems capable of supporting a browser or browser-enabled application, such as Microsoft™, Windows™, and/or Linux.

In some embodiments, the external computing devices 402a, 402b through 402n shown each may include at least includes a computer-readable medium, such as a random-access memory (RAM) or FLASH memory, coupled to a processor. In some embodiments, examples of the external computing devices 402a through 402n may be any type of processor-based platforms that are connected to a network 410 such as, without limitation, servers, personal computers, digital assistants, personal digital assistants, smart phones, pagers, digital tablets, laptop computers, Internet appliances, cloud-based processing platforms, and other processor-based devices. In some embodiments, external computing devices 402a through 402n may be specifically programmed with one or more application programs in accordance with one or more principles/methodologies detailed herein. In some embodiments, external computing devices 402a through 402n may operate on any of a plurality of operating systems capable of supporting a browser or browser-enabled application, such as Microsoft™, Windows™, and/or Linux. In some embodiments, external computing devices 402a through 402n shown may be accessed by, for example, the system 102 by executing a browser application program such as Microsoft Corporation's Internet Explorer™, Apple Computer, Inc.'s Safari™, Mozilla Firefox, and/or Opera to obtain the live data points. In some embodiments, through the system 102, the entity associated with the system 102 may communicate over the exemplary network 410 with the external computing devices 402a through 402n to obtain the live data points.

In some embodiments, the network based system 400 may include at least one database 420. The database 420 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

In some embodiments, the network based system 400 may also include and/or involve one or more cloud components. Cloud components may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.). In some embodiments, the computer-based systems/platforms, computer-based devices, components, media, and/or the computer-implemented methods of the present disclosure may be specifically configured to operate in or with cloud computing/architecture such as, but not limiting to infrastructure a service (IaaS), platform as a service (PaaS), and/or software as a service (SaaS).

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components and cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux™, (2) Microsoft Windows™, (3) OS X (Mac OS), (4) Solaris™, (5) UNIX™ (6) VMWare™, (7) Android™, (8) Java Platforms™, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

What is claimed is:

1. A computer-implemented method, comprising:
obtaining, by a computer system from a first computing device, a first dataset indicative of a movement of objects associated with a first time period;
extracting, by the computer system and via execution of a first machine learning model, a first set of feature values based on the first dataset;
determining, by the computer system, a physical resource allocation based on the first set of feature values and a reference dataset; and
dynamically configuring, by the computer system, usage of one or more physical resources associated with a physical building space based on the physical resource allocation.

2. The computer-implemented method according to claim 1, further comprising:
determining, by the computer system and via execution of a second machine learning model, the dynamic configuration of one or more physical resources associated with the physical building space based on the physical resource allocation.

3. The computer-implemented method according to claim 2, wherein the dynamic configuration of the one or more physical resources further comprises:
allocating a plurality of workstations associated with the physical building space based on a ranking of each workstation of the plurality of workstations.

4. The computer-implemented method according to claim 1, further comprising:
obtaining, by the computer system from the first computing device, data indicative of the movement of objects associated with a second time period;
extracting, by the computer system and via execution of the first machine learning model, a second set of feature values based on the data indicative of the movement of objects associated with the second time period;
obtaining, by the computer system, data representative of the physical resource allocation based on the second time period;
determining, by the computer system, a reference dataset based on the second set of feature values and the physical resource allocation data; and
training, by the computer system, the first machine learning model based on the reference dataset.

5. The computer-implemented method according to claim 1, wherein the first dataset comprises one or more images captured by one or more recording devices.

6. The computer-implemented method according to claim 5, wherein extracting the first set of feature values from the one or more images further comprises:
applying, via the first machine learning model, one or more computer vision techniques to the one or more images,
identifying, by the computer system, one or more pixel groups in the one or more images,
determining, by the computer system, a first set of characteristics based on the one or more images and associating the first set of characteristics to the one or more pixel groups, and
deriving, by the computer system, a traffic density based on the first set of characteristics and the first set of feature values.

7. The computer-implemented method according to claim 5, wherein the one or more images comprise scenes of a vehicle pathway.

8. The computer-implemented method according to claim 5, wherein the one or more images comprise scenes of one or more public transportation stations.

9. The computer-implemented method according to claim 1, wherein the first dataset comprises one or more images captured by one or more recording devices,
wherein the computer-implemented method further comprises:
obtaining, by the computer system from a second computing device, text data indicative of an increase or decrease to the physical resource allocation associated with the first time period; and
extracting, by the computer system and via execution of the first machine learning model, a third set of feature values based on the text data;
wherein determining the physical resource allocation is further based on the third set of feature values.

10. The computer-implemented method according to claim 9, wherein extracting the third set of feature values from the text data comprises:
identifying, by the computer system and the first machine learning model, one or more key terms in the text data,
determining, by the computer system, a second set of characteristics based on the key terms and the text data, and
deriving, by the computer system, an indication corresponding to the increase or decrease to the physical resource allocation based on the third set of feature values and the second set of characteristics.

11. A system comprising:
one or more processors; and
a non-transitory computer readable medium having stored thereon instructions that are executable by the one or more processors to cause the system to perform operations comprising:
obtain a first dataset indicative of a movement of objects associated with a first time period from a first computing device;
extract, via execution of a first machine learning model, a first set of feature values based on the first dataset;
determine a physical resource allocation based on the first set of feature values and a reference dataset;
determine, via execution of a second machine learning model, a dynamic configuration of one or more physical resources associated with a physical building space based on the physical resource allocation; and
dynamically configure usage of the one or more physical resources associated with the physical building space based on the physical resource allocation.

12. The system according to claim 11, wherein determining the dynamic configuration of the one or more physical resources associated with the physical building space further comprises:
allocating a plurality of workstations associated with the physical building space based on a ranking of each workstation of the plurality of workstations.

13. The system according to claim 11, further comprising:
obtain data indicative of the movement of objects associated with a second time period from the first computing device;
extract a second set of feature values based on the data indicative of the movement of objects associated with the second time period;
obtain data representative of the physical resource allocation based on the second time period;
determine a reference dataset based on the second set of feature values and the physical resource allocation data; and
train the first machine learning model based on the reference dataset.

14. The system according to claim 13, further comprising:
obtain data representative of the configuration of the one or more physical resources associated with the physical building space based on the second period of time;
extract a third set of feature values based on data representative of the configuration of the usage of the one or more physical resources; and
training the second machine learning model based on the reference dataset;
wherein the reference dataset further comprises the third set of feature values.

15. The system according to claim 11, further comprising a building management system,
wherein the building management system comprises an electrical distribution system, and
wherein dynamically configuring usage of the one or more physical resources associated with the physical building space within the second time period causes the system to further perform operations comprising:
configure the electrical distribution system to reduce a power consumption based on the physical resource allocation.

16. The system according to claim 11, further comprising a building management system,
wherein the building management system comprises a HVAC system,
wherein dynamically configuring usage of one or more physical resources associated with the physical building space within the second time period further causes the system to further perform operations comprising:
control the HVAC system to isolate unallocated zones based on the physical resource allocation.

17. A computer program product embodied on one or more non-transitory computer readable media having stored thereon instructions that are executable by one or more processors to cause the computer program product to perform operations comprising:
obtain a first dataset indicative of a movement of objects associated with a first time period from a first computing device;
extract, via execution of a first machine learning model, a first set of feature values based on the first dataset;
determine a physical resource allocation based on the first set of feature values and a reference dataset;
determine, via execution of a second machine learning model, a dynamic configuration of one or more physical resources associated with a physical building space based on the physical resource allocation; and
dynamically configuring usage of the one or more physical resources associated with the physical building space based on the physical resource allocation.

18. The computer program product according to claim 17, wherein the first dataset comprises one or more images captured by one or more recording devices,
wherein extracting the first set of feature values from the one or more images causes the computer program product to further perform operations comprising:
apply one or more computer vision techniques to the one or more images,
identify one or more pixel groups in the one or more images,
determine a first set of characteristics from the one or more images and associating the first set of characteristics to the one or more pixel groups, and
derive a traffic density based on the first set of characteristics and the first set of feature values.

19. The computer program product according to claim 18, the computer program product further performs operations comprising:
obtain text data indicative of an increase or a decrease to the physical resource allocation associated with the first time period from a second computing device;
identify, by the first machine learning model, one or more key terms in the text data;
determine a second set of characteristics based on the one or more key terms;
extract, via execution of the first machine learning model, a third set of feature values based on the text data and the second set of characteristics; and
derive an indication of the increase of the decrease to the physical resource allocation based on the third set of feature values and the second set of characteristics;
wherein determining the physical resource allocation is further based on the third set of feature values.

20. The computer program product of claim 17, wherein dynamically configuring usage of the one or more physical resources associated with the physical building space based on the physical resource allocation causes the computer program product to further perform operations comprising:
control an electrical distribution in the physical building space to conserve a power usage based on the physical resource allocation,
control a HVAC system to isolate unoccupied zones in the physical building space based on the physical resource allocation, and
allocate a plurality of workstations associated with the physical building space based on a ranking of each workstation of the plurality of workstations.
